(19) United States
(12) Patent Application Publication
(10) Pub. No.: US 2017/0240426 A1
(43) Pub. Date: Aug. 24, 2017

(54) METHOD OF FUNCTIONALIZING SURFACES OF CARBON NANOMATERIALS

(71) Applicant: Nanyang Technological University, Singapore (SG)

(72) Inventors: Xiao Hu, Singapore (SG); Xuelong Chen, Singapore (SG)

(21) Appl. No.: 15/505,047

(22) PCT Filed: Sep. 16, 2015
(86) PCT No.: PCT/SG2015/050323

§ 371 Date: Feb. 17, 2017

(30) Foreign Application Priority Data
Sep. 16, 2014 (SG) 10201405784X

(51) Int. Cl. C01B 31/02; C08K 3/04

(52) U.S. Cl. CPC C01B 31/0273; C01B 31/0253; C08K 3/041; C01B 2202/06; B82Y 30/00

(57) ABSTRACT

The invention relates to a method of functionalizing surfaces of carbon nanomaterials using oxygen in the air. The method is clean and eco-friendly with virtually zero chemical usage and zero waste generation. The dispersion of the surface-functionalized carbon nanomaterials is excellent in organic solvents.

### CROSS-REFERENCE TO RELATED APPLICATION

This application claims the benefit of priority of Singapore Patent Application No. 10201405784X, filed Sep. 16, 2014, the contents of which being hereby incorporated by reference in its entirety for all purposes.

### TECHNICAL FIELD

The invention relates to a method of functionalizing surfaces of carbon nanomaterials using oxygen in the air.

### BACKGROUND

Carbon nanotubes (CNTs) are quasi one-dimensional materials. In the last two decades, carbon nanotubes have been widely investigated because of their outstanding mechanical, chemical, electrical, electronic and thermal properties. Their applications include composite materials, sensors, photovoltaic devices, actuators, transistors and energy storage and conversion devices. Due to their high aspect ratio (length in the order of micrometers and diameters less than 100 nm) and strong intermolecular van der Waals forces, CNTs usually form highly entangled bundles and networks making them difficult to be dispersed in solvents. Poor dispersion of CNTs seriously limits their potential applications. For example, achieving a high level dispersion is critical for many applications derived from CNT based suspensions or nanocomposites.

Multiple strategies have been explored to disperse CNTs including covalent and non-covalent modifications. Oxidation using various strong acids is often a common and effective starting point of chemical modification. Acid oxidation brings in surface functional groups to render good dispersion in aqueous solutions and also enable further modification, for example, grafting of polymers. Many strong oxidants have been used to treat carbon nanotubes and various polar groups including carboxylic, hydroxyl and ketone groups can be created on the surface of CNTs. These polar groups can interact with the solvent molecules and thus increase the dispersability of carbon nanotubes most effectively in aqueous solutions. In spite of the effectiveness of acid/chemical oxidation, the drawbacks of this approach are obvious. Firstly, the use of large quantity of strong acids leads to pollutions that impair potential large scale industrial level production. Purification process can be prohibitively tedious and time consuming, usually involving multi-step washing, filtration, centrifugation, dialysis and drying. Furthermore, excessively large amount of water is consumed and wastewater is generated during an acid oxidative treatment of CNTs. Besides, acid oxidation often leads to lower yield due to wastage and difficulties in control. Wet-chemical treatment of CNTs usually needs freeze-drying to ensure re-dispersability and hence is highly energy consuming.

Non-covalent wrapping of specific polymers on the surface of carbon nanotube is another method to improve the dispersion of carbon nanotubes. Different from oxidation, physical wrapping does not create any new groups on carbon nanotubes. Instead, the polymer chains physically interact with the carbon nanotube to form a supramolecular structure. Non-covalent polymer wrapping can well retain the structure of the carbon nanotubes. However, many of those effective wrapping polymers have to be specially designed and synthesized. The processes also consume large amount of solvents making it difficult to implement.

Therefore, there remains a need to provide for a method of functionalizing carbon nanomaterials such as carbon nanotubes for effective dispersion in organic solvents.

### SUMMARY

Surface functionalization is often a prerequisite to achieve good dispersion of carbon nanomaterials, such as carbon nanotubes, which is critical for their wide ranging applications. It is herein described a facile and effective route for surface functionalization of carbon nanotubes through air annealing. The dispersion of the annealed carbon nanotubes is excellent in organic solvents. The new route is clean and eco-friendly with virtually zero chemical usage and zero waste generation. Qualitative and quantitative analysis of morphological and chemical structures revealed that the surface oxidative reactions of the nanotubes during air annealing are well-defined and can be controlled remarkably well. The investigation also revealed that air-annealing causes much less damage of the graphitic structure in the treated nanotubes. Mechanistic aspects of this facile functionalization method are also discussed.

According to various embodiments of the invention, there is disclosed a method of functionalizing surfaces of carbon nanomaterials using oxygen in the air. The method includes annealing the carbon nanomaterials with air. The method further includes supplying one or more diluent gases to the carbon nanomaterials during the annealing. The one or more diluent gases are inert to the functionalization of the carbon nanomaterials surfaces.

Preferably, the one or more diluent gases include nitrogen.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows a schematic illustration of present air annealing process of CNTs and their dispersion states in organic solvent before and after treatment.

FIG. 2 shows the annealing conditions, sample codes and dispersion test. The percentage value given indicates the mass residue or yield after annealing. All dispersion samples were prepared by mixing 0.5 mg CNTs in 10 ml ethanol under bath sonication for 1 h. The digital images were taken after 1 week of stationary storage. (* Low yields of CNTs due to excessive over-oxidation)

FIG. 3 show TEM images of (a) raw CNTs, (b) mixed acids treated CNTs, (c) sample B1 annealed at 500° C. for 30 min, and (D) sample A4 annealed at 450° C. and 120 min.

FIG. 4 shows Raman spectra and I_{D}/I_{G} value of (a) raw CNTs, (b) B1 (500° C., 30 min), (c) A4 (450° C., 120 min), (d) acid treated sample, and (e) sample treated at 650° C.

FIG. 5 shows FESEM images of PVDF/CNTs composites with 0.2 wt % (a, b) raw CNT and (c, d) sample A4.

FIG. 6 shows XPS spectra of (a) raw CNTs, (b) sample C1 air annealed at 550° C. for 30 min, and (c) acid treated CNTs.

FIG. 7 shows deconvoluted high resolution XPS C 1s spectra of (a) raw CNTs, (b) B1, (c) sample C1, and (d) acid treated CNTs. Their corresponding O is spectra are given in (e), (f), (g), and (h), respectively.

FIG. 8 shows the proposed CNT surface functionalization mechanisms by air annealing: (a) raw CNT, (b) formation of peroxide intermediates after air annealing, (c) bond re-arrangements, and (d) functionalized CNT. It is noted that I and II represent different sites on the CNT sample showing the mechanisms of forming C—O—C and C═O via 1,4- and 1,2-peroxidation, respectively.

FIG. 9 shows Table 1: Compositions of different functional groups determined from XPS spectra for air annealed CNTs.

FIG. 10 shows a TGA curve of raw CNTs in air condition and the decomposition of CNTs can be roughly divided into four steps. Before 500° C., there is no obvious change for CNTs. The minor weight cut-off is due to the elimination of moisture and some other absorbed materials. Slow oxidation might occur within this temperature range. Between 500 to 550° C., weight decreases apparently but the decomposition rate is quite mild. High temperature before 550° C. is promising in functionalizing CNTs without serious decomposition. Between 550 and 700° C., CNTs were burned into ash very quickly; beyond 700° C. there is only metal oxide left. In order to verify the hypothesis of air annealing, a trial sample of CNTs were treated at 650° C. Due to the high decomposition rate, the temperature was increased to set value and stopped without any isothermal annealing process.

FIG. 11 shows TEM images (A, B) of a CNT trial sample air annealed at 650° C. Compared with the rather clean surfaces of raw CNTs, the CNTs from trial sample looks sticky to each other after high temperature treatment, though the truncation effect is not obvious. From the high magnification picture in (B), the crystalline structure of CNT walls were seriously damaged and large amount of carbonaceous carbon was attached onto both the inner and outer surface of CNTs. This indicates the air is very aggressive to CNTs at this temperature. Dispersion test showed raw CNTs begins to settle down simultaneously after the sonication stops. In fact, the raw CNTs form flocculent structure and cannot be uniformly dispersed even with sonication. By contrast, the trial sample can be stable for months without obvious sediment against light.

FIG. 12 shows a dispersion test of raw CNTs (left) and annealed sample (B1, right) in various solvents. All dispersion samples were sonicated for 60 min and digital photos were taken after 1 week of storage (0.5 mg CNTs in 10 ml solvent). Air annealed CNTs readily dispersed in common organic solvents and the suspensions were stable for more than one week, while raw CNTs precipitated immediately after removal of the bottle from the sonicator.

FIG. 13 shows Table 2. Compositions of different functional groups determined from XPS spetra for acid treated CNTs.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and changes may be made without departing from the scope of the invention. The various embodiments are not necessarily mutually exclusive, as some embodiments can be combined with one or more other embodiments to form new embodiments.

It is herein described a facile method to prepare surface-functionalized carbon nanomaterials, such as carbon nanotubes, by annealing the carbon nanomaterials with air at moderately elevated temperatures. In this case, oxygen in the air is used as an effective oxidant to functionalize the carbon nanomaterials. Furthermore, the oxidation is highly controllable by tuning the annealing temperature, duration, air and diluent gas(es) volume ratio, and the respective air and diluent gas(es) flow rate. As a result, functional groups that aid the carbon nanomaterials dispersion in organic solvents are generated on the surface while the mechanical and structural integrity of the carbon nanomaterials is remarkably well maintained. This is a virtually chemical-free method without the use of any solvent, acid or water. There is also significant energy and time saving due to the elimination of freeze-drying processes of the treated carbon nanomaterials. The test results confirm that the air annealed carbon nanomaterials can be particularly well dispersed in organic solvents. Detailed analysis revealed that this unexpected desirable dispersion behavior in organic solvents can be attributed to their different surface functional groups, i.e., absence of carboxylic and hydroxyl groups, compared to the acid treated counterparts. In addition, the air-annealing causes much less structural damage to the carbon nanomaterials.

Accordingly, various embodiments of the invention relates to a method of functionalizing surfaces of carbon nanomaterials using oxygen in the air.

In present context, the carbon nanomaterials comprise single-walled, double-walled, or multi-walled carbon nanotubes, carbon nanofibers, graphene, activated carbons, carbon blacks, carbon onions, or nanoscale diamond and diamondoids. According to various embodiments, carbon nanomaterials comprising carbon nanotubes are herein described in details as exemplary embodiments and it is to be appreciated that the scope of present disclosure is not limited to carbon nanotubes.

As used herein, the term “carbon nanotube” (CNT) refers to a cylindrical single-, double- or multi-walled structure in which the at least one wall of the structure is predominantly made up of carbon. Generally, carbon nanotubes can be formed by methods such as arc-discharge, laser ablation and chemical vapor deposition. The carbon nanotubes may be pre-treated or untreated after formation.

The arc-discharge method creates CNTs through arc-vaporization of two carbon rods placed end to end, separated by a space of about 1 mm, in an enclosure that is usually filled with inert gas at low pressure. A direct current creates a high temperature discharge between the two electrodes. The discharge vaporizes the surface of one of the carbon electrodes, and forms a small rod-shaped deposit of carbon atoms on the other electrode.

In the laser ablation method, CNTs can be prepared by laser vaporization of graphite rods with a catalyst mixture of cobalt and nickel at high temperatures in flowing argon, followed by heat treatment in a vacuum to remove impurities. The initial laser vaporization pulse can be followed by a second pulse, to vaporize the target more uniformly. The use of two successive laser pulses minimizes the amount of carbon deposited as soot. The second laser pulse breaks up the larger particles ablated by the first one, and feeds them into the growing nanotube structure. By varying the growth temperature, the catalyst composition, and other process parameters, the average nanotube diameter and size distribution can be varied.

Chemical vapor deposition (CVD) can also be used to produce the CNTs. It can proceed through the dissociation of carbon-containing molecules catalyzed by transition-metal such as nickel and cobalt. In thermal CVD, a carbon-containing gas mixture is heated by a conventional heat source such as a resistive or inductive heater, furnace, or IR lamp. To initiate the growth of nanotubes, a process gas such as ammonia or nitrogen and a carbon containing gas such as acetylene or methane are bled into the reactor. Nanotubes grow at the sites of the metal catalyst, whereby the carbon-containing gas is broken apart at the surface of the catalyst particle and the carbon is transported to the edges of the particle where it forms the nanotubes. Plasma-enhanced CVD (PECVD) modifies this method by the application of an electrical discharge ignited in the gas mixture.

The number of shells in a carbon nanotube can vary from one, i.e., constituting a single-walled carbon nanotube (SWNT or SWCNT), to as many as 50 shells, in which case it is termed a multi-walled carbon nanotube (MWNT or MWCNT), each pair of adjacent shells in such structure having a spacing between layers that is on the order of 0.34 nanometers, wherein the shells may be concentric. Examples of carbon nanotubes that can be used in the present invention include, but are not limited to, single-walled carbon nanotubes, double-walled carbon nanotubes (DWNT or DWCNT), multi-walled carbon nanotubes, bundles of carbon nanotubes and any combination thereof. In some illustrated embodiments, the carbon nanotube is a single-walled carbon nanotube.

The carbon nanotube can be a metallic carbon nanotube, or a semiconducting carbon nanotube, or a combination of both. The carbon nanotube may be of any length and diameter. Each carbon nanotube may have a diameter of about 0.3 to 200 nm, such as about 3 to 200 nm, about 1 to 100 nm, about 0.3 to 50 nm, or about 1 to 5 nm. In some embodiments, each carbon nanotube can have a length of about 0.5 to 300 μm, such as about 0.5 to 200 μm, about 0.5 to 100 μm or about 0.5 to 50 μm. Carbon nanotubes are typically 0.3 to 50 nanometers in diameter and have a length of 0.5 to 100 micrometers. Atomic Force Microscopy (AFM) and/or Raman Scattering Spectroscopy may for instance be used to determine the dimensions of single-walled carbon nanotubes. Generally, the longer the length of the carbon nanotubes, the greater is the tendency of the nanotubes to entangle. As a result, an entangled mass or cluster of carbon nanotubes may be formed.

In present context, surface functionalization and related terms generally refer to modifying the surfaces of the carbon nanomaterials. In particular, functional groups such as ether (C—O—C) and quinone (C═O) groups are formed on the surfaces of the carbon nanomaterials after annealing. Even more specifically, polar functional groups such as hydroxyl (—OH) and carboxylic (—COOH) are not formed on the surfaces of the carbon nanomaterials.

The method includes annealing the carbon nanomaterials with air. Generally, annealing refers to treatment of the carbon nanomaterials by heating to a predetermined temperature, holding for a certain period, and then cooling to room temperature, for example. In one embodiment, the carbon nanomaterials may be annealed in annealing equipment such as commercial product Thermal Gravimetric Analyser (Q 500, TA Instruments). Other suitable annealing equipment include tube furnace, batch furnace, or any vessel, equipment or setup with temperature controllable means.

The oxidant, i.e. oxygen in the air, may be supplied to the carbon nanomaterials during annealing at a constant flow rate. For example, air may be supplied to the carbon nanomaterials in the annealing equipment at a flow rate of 1 ml/min, 2 ml/min, 3 ml/min, 4 ml/min, 5 ml/min, 6 ml/min, 7 ml/min, 8 ml/min, 9 ml/min, 10 ml/min, or more.

In one disclosed embodiment, air is supplied at a constant flow rate of 5 ml/min.

Air may also be supplied to the carbon nanomaterials at a variable flow rate, such as at an increasing rate or a decreasing rate.

The method further includes supplying one or more diluent gases to the carbon nanomaterials during the annealing. The one or more diluent gases are inert to the functionalization of the carbon nanomaterials surfaces. In other words, the one or more diluent gases serve to dilute the concentration (v/v) of the oxygen (or air) exposed to the carbon nanomaterials during annealing. The one or more diluent gases play no or minimal role in modifying the surfaces of the carbon nanomaterials, i.e. chemically inert to the functionalization of the carbon nanomaterials.

The concentration of air exposed to the carbon nanomaterials during annealing may be controlled by varying the volume ratio of air to one or more diluent gases. Thus, in various embodiments, the volume ratio of air to the one or more diluent gases may be between 1:2 and 1:20, such as 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, or 1:20.

In one disclosed embodiment, the volume ratio of air to the one or more diluent gases may be fixed at 1:10. This may be achieved, for example, by manipulating the flow rate of the one or more diluent gases supplied to the carbon nanomaterials during annealing. In one exemplified embodiment, for a fixed air flow rate of 5 ml/min, the flow rate of the one or more diluent gases may be fixed at 50 ml/min. As mentioned in earlier paragraphs, other volume ratio, and therefore other flow rate ratio of air to the one or more diluent gases may also be suitable.

As mentioned in earlier paragraphs, any diluent gas may be suitable for use in the present method so long as the gas serves to dilute the concentration of air supplied during the annealing and the gas does not participate in the functionalization of the carbon nanomaterials surfaces.

In various embodiments, the one or more diluent gases include but are not limited to, nitrogen, helium, argon, krypton, xenon, carbon dioxide and radon.

In one disclosed embodiment, the diluent gas consists of nitrogen.

In another embodiment, the diluent gases include a mixture of nitrogen and one other diluent gas.

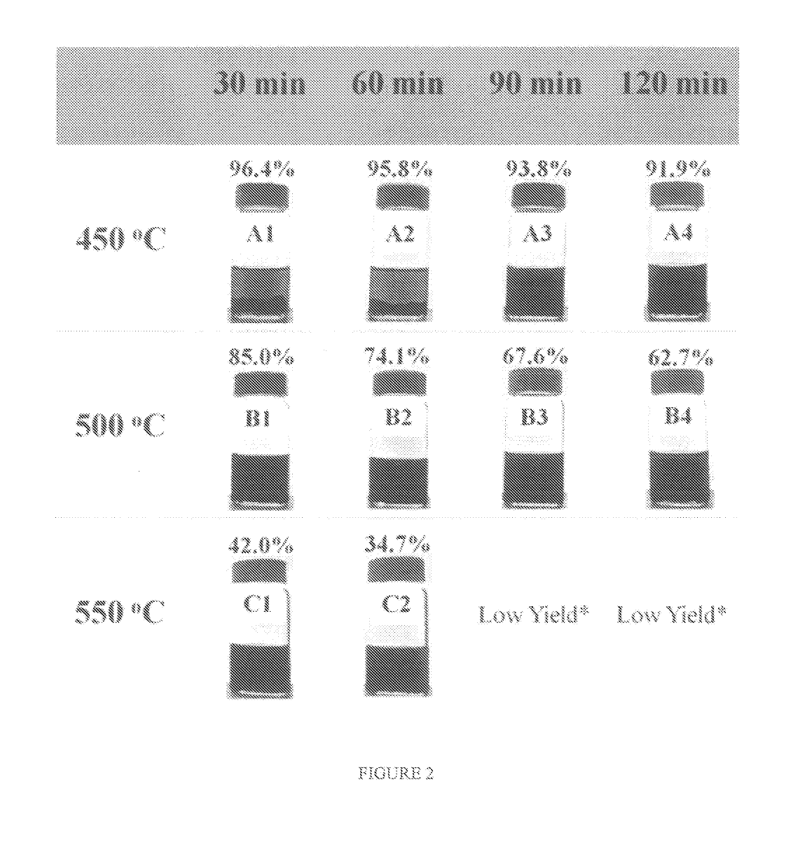

In various embodiments, the carbon nanomaterials may be annealed at an annealing temperature between 450 and 550° C. In case of the carbon nanomaterials being carbon nanotubes, it has been found out annealing at a temperature below 450° C. is inadequate to give rise to sufficient surface functionalization, while annealing at a temperature above 550° C. for longer durations causes excess weight loss and hence leads to a low yield. More discussion on the suitability of annealing temperatures is found in the example section and is illustrated in FIG. 2.

In various embodiments, the carbon nanomaterials may be annealed at a heating rate of 5° C./min or more. For example, the carbon nanomaterials may be annealed at a heating rate of 5° C./min, 6° C./min, 7° C./min, 8° C./min, 9° C./min, 10° C./min, 11° C./min, 12° C./min, 13° C./min, 14° C./min, 15° C./min, 16° C./min, 17° C./min, 18° C./min, 19° C./min, or 20° C./min.

In one disclosed embodiment, the carbon nanomaterials may be annealed at a heating rate of 5° C./min.

It has been found that the period of annealing the carbon nanomaterials may have an impact on the yield and quality in terms of oxygen content in the carbon nanomaterials. Consequently, this would have an impact on the dispersability of the functionalized carbon nanomaterials in organic solvents, such as but not limited to ethanol, acetone, chloroform, and N,N-dimethylformamide. More discussion on this topic can be found in the example section.

Accordingly, in various embodiments, the carbon nanomaterials are annealed for 150 min or less. For example, the annealing period may be 30 min, 35 min, 40 min, 45 min, 50 min, 55 min, 60 min, 65 min, 70 min, 75 min, 80 min, 85 min, 90 min, 95 min, 100 min, 105 min, 110 min, 115 min, 120 min, 125 min, 130 min, 135 min, 140 min, 145 min or 150 min.

In summary, it is herein described a facile and effective route for surface functionalization of carbon nanomaterials, for example carbon nanotubes, through air annealing. The dispersion of the annealed carbon nanotubes is excellent in organic solvents. The new route is clean and eco-friendly with virtually zero chemical usage and zero waste generation. Qualitative and quantitative analysis of morphological and chemical structures revealed that the surface oxidative reactions of the nanotubes during air annealing are well-defined and can be controlled remarkably well. The investigation also revealed that air-annealing causes much less damage of the graphitic structure in the treated nanotubes. Mechanistic aspects of this facile functionalization method are also discussed in the example section.

In order that the invention may be readily understood and put into practical effect, particular embodiments will now be described by way of the following non-limiting examples.

### Examples

### EXPERIMENTAL

### Materials

Multi-walled carbon nanotubes with average diameter of 10 nm and average length of 1.5 μm were purchased from Nanocyl, Belgium. The surface area is 250-300 m²/g. Poly (vinylidene fluoride) (PVDF) powder was purchased from Alfa Aesar. The solvents used include analytical grade ethanol, acetone, chloroform and N,N-dimethylformamide (DMF) were purchased from Sigma Aldrich.

### Air Annealing

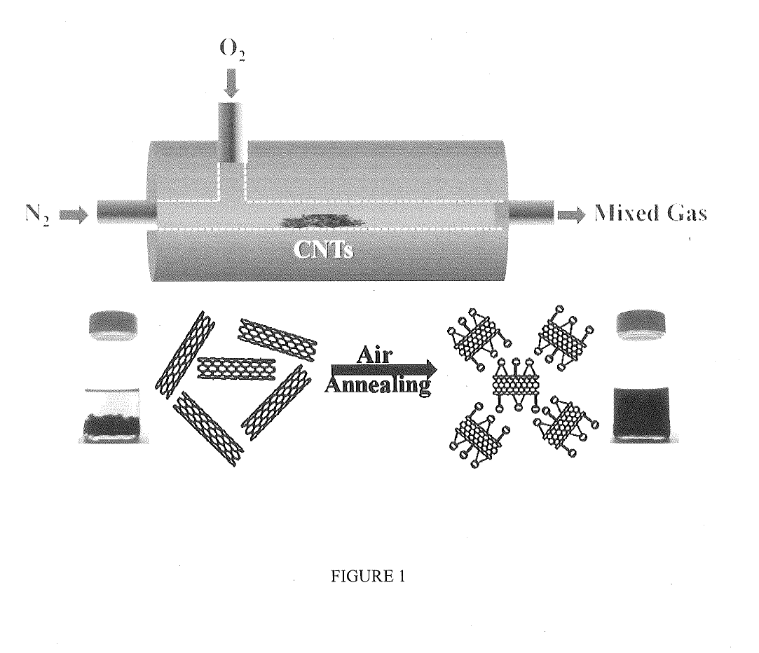

Annealing process was performed in a Thermal Gravimetric Analyser (Q 500, TA Instruments). Raw CNTs without any pre-treatment were placed in a platinum boat and were heated to the pre-set temperature between 450 and 550° C. at 5° C./min with an air flow rate of 5 ml/min. A simultaneous flow of N₂ at 50 ml/min was used because preliminary tests indicated that dilution is needed in order to achieve controlled surface oxidation of the CNTs. A schematic illustration of the process is given in FIG. 1. For comparison, acid treated MWCNTs were also prepared and studied.

### Characterizations

The morphology of CNTs was studied using a high resolution transmission electron microscope (TEM, Carl Zeiss Libra 120 Plus). The morphology of prepared composite samples was studied with field emission scanning electron microscope (FESEM). SEM samples were prepared by firstly immersing samples inside liquid nitrogen to prepare cyro-fractured surface and then coated with platinum for 45 s before investigated by JEOL JSM-7600F. Compositional analysis of carbon nanotube was carried out using an X-ray photoelectron spectroscopy (XPS) equipped with an Axis Ultra spectrometer (Kratos Analytical). A monochromated Al Kα X-ray (1486.7 eV) operating at 15 kV was used as the source. Raman spectra were recorded by a Witec alpha 300 SR spectrometer with an Argon ion laser (488 nm, 20 mW) as the excitation source. For quantitative analysis, five spectra were recorded at difference location on each sample.

### Preparation of Acid Treated CNTs for Comparative Study

Acid treated CNTs were prepared for comparative study; the fabrication process is as follows. In the first step, 1.0 g of as received MWCNTs is transferred into a clear bottle with 200 ml water to do the probe sonification for 30 min (3 s on and 3 s off, with 100% amplitude). After sonification, the muddy solution is filtered by 0.2 μm membrane. The product is dried in vacuum oven overnight to evacuate the water. The product obtained from step 1 is transferred to a 250 ml round bottom flask with 75 ml sulfuric acid and 25 ml nitric acid (v/v=3:1). The solution is sonicated for 30 min in bath sonicator at room temperature to disperse CNTs in the mixed acids. Then, MWCNTs with mixed acids is reflux for 60 min at 90° C. with vigorous magnetic stirring. Afterwards, the diluted solution is filtered by acid-resistance membrane with pore size 0.2 μm. Multiple washing by deionized water was done until the pH of the functionalized CNTs is around 6 to 7. The filtered CNTs are then rinsed with acetone to remove the most of the washing water. The yield is dried in vacuum oven under reduced pressure overnight at 50° C. before obtaining the final sample.

### Dispersion of Air-Annealed CNTs in Polymer

0.2 wt % CNTs was processed with high power sonication (ultrasonic processor VCX 130, SONICS) for 5 min in DMF. After that, dissolved PVDF in 50 ml DMF was mixed with CNTs solution by magnetic stirring for 1 h and bath sonication for 1 h. The uniform PVDF/CNTs/DMF solution is dried at 100° C. and 120° C. in a vacuum oven for overnight. Cryo-fractured surfaces were examined using a high resolution field-emission SEM.

### Results and Discussion

One of the motivations of present disclosure is to effectively functionalize carbon nanotubes using oxygen in the air at elevated temperatures without damaging their integrity and yet achieving the highest possible yield. Therefore, in this study, the oxygen concentration in the air is deliberately further diluted using up to 10 times of N₂ to ensure the process is well controlled.

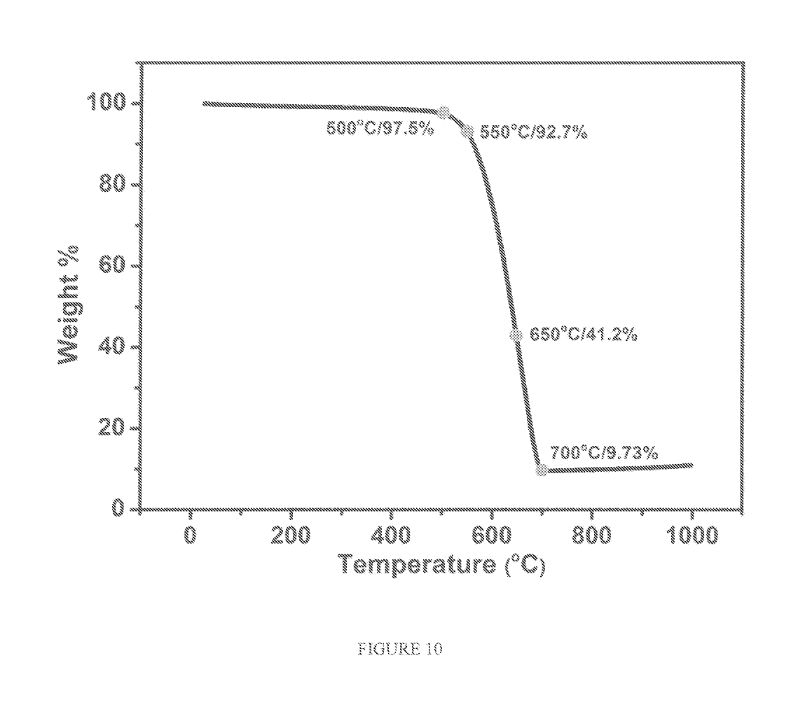

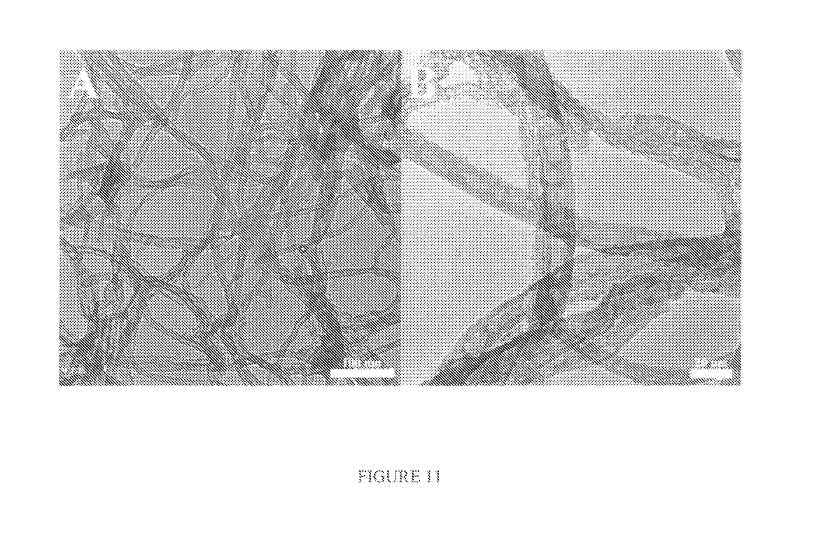

Based on TGA analysis (FIG. 10) and preliminary study, a suitable temperature range was set between 450 and 550° C. for detailed study. In fact, it is not difficult to understand that oxidation can only occur above a critical temperature and accelerates as temperature increases, and that too high a temperature leads to excess oxidation of CNTs in a short time resulting in excessive weight loss and hence low yields. For example, CNTs treated at 650° C. led to 59% weight loss, i.e., low yield. Although the treated nanotube can form stable solvent dispersion for months, more detailed studies using TEM (FIG. 11) and Raman spectroscopy revealed substantial damage of the graphitic structure. FIG. 2 illustrates the dispersion state of the annealed CNTs. The sample codes, their corresponding annealing temperatures/durations and percentage yields are also given.

It is noted that dispersion of treated CNTs improves with annealing temperatures and time in general as one might expect. Annealing at a temperature below 450° C. is inadequate to give rise to sufficient surface functionalization, while annealing at a temperature above 550° C. for longer durations causes excess weight loss and hence leads to a low yield. FIG. 2 clearly indicates that it is critical to control the annealing conditions in order to achieve a good dispersion of CNTs in organic solvents while maintaining a high yield as well as avoiding structural damages (see discussion on Raman spectra in later paragraphs) due to over-oxidation. Samples A4 and B1 stood out due to their combination of high yields and excellent dispersion. In order to further understand the air-annealing effect on the functionalization of CNTs, detailed qualitative and quantitative analyses were carried out on the treated CNTs.

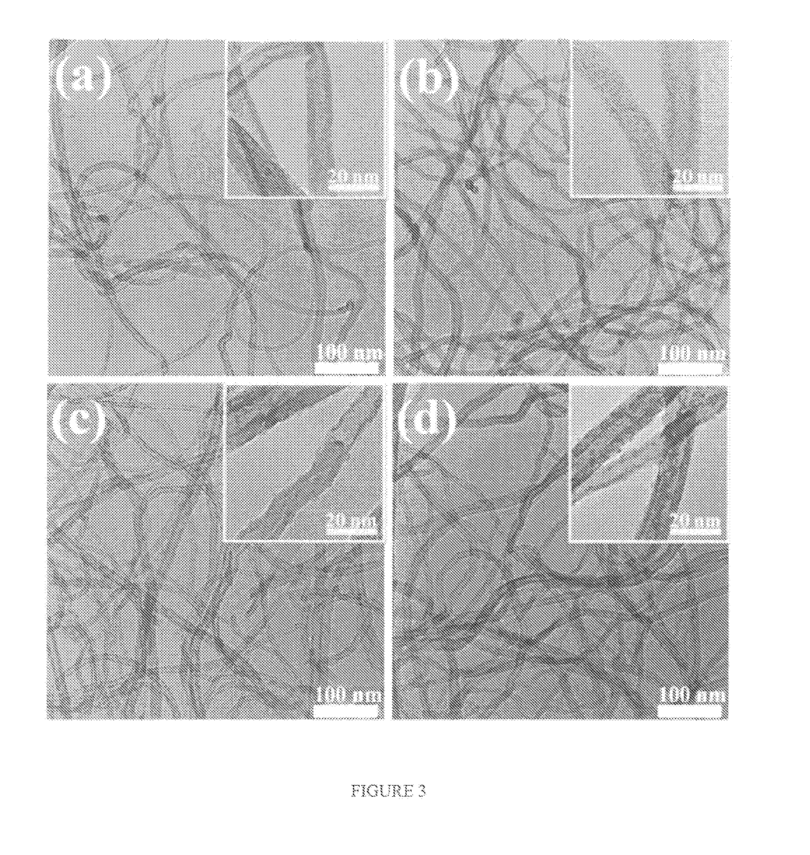

FIG. 3 shows the TEM images of the air annealed CNTs (samples B1, A4). Raw CNTs and acid treated CNTs are also analyzed for comparison. It can be clearly seen that samples A4 and B1 do not show significantly different overall morphology in comparison to raw CNTs except there are subtle changes on the CNT surfaces (see (c) and (d) of FIG. 3). The weight losses for these samples are both less than 15%. These results demonstrate that such a facile air-annealing can be well harnessed for CNT treatment to achieve excellent dispersion at relatively high yields without causing excessive damages to the integrity of the graphitic structure. However, in the acid treated sample, a relatively thick amorphous layer is observed (see (b) of FIG. 3), indicating more severe damage in the graphitic structure of the CNTs. Such amorphous layer was reported for acid treated CNTs which has an adverse effect on their thermal stability and electric properties. Therefore, controlled air annealing clearly has its advantages for CNT treatment in terms of maintaining intrinsic CNT structure.

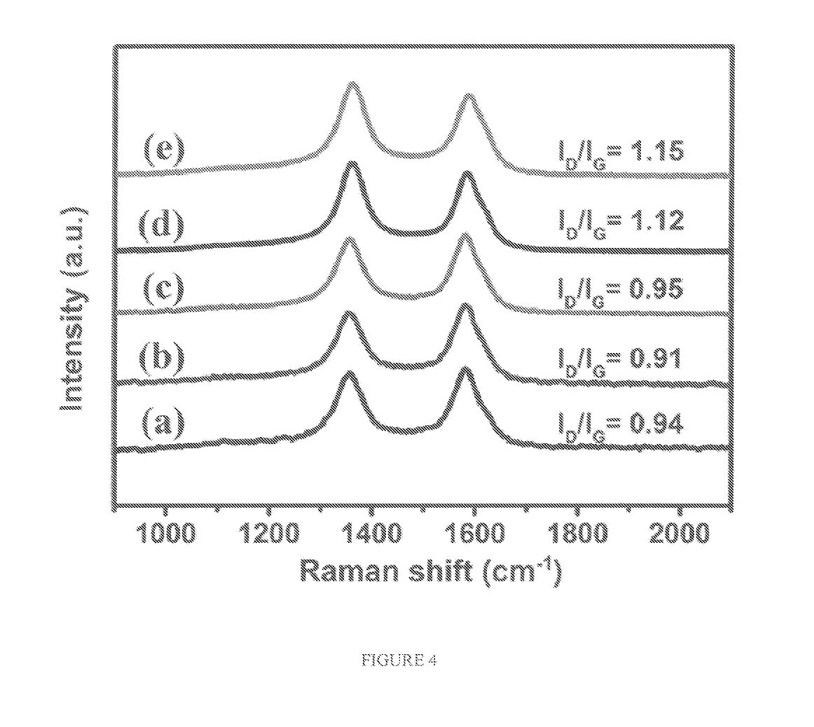

It is known that Raman spectra of CNTs are sensitive to any chemical modifications. The so-called D band around 1360 cm-1 is closely related to the degree of ordering, while the G band at 1585 cm-1 is originated from the graphitic carbon. The intensity of D band increases as the increase of defects sites, impurities and the amount of amorphous carbon. The I_{D}/I_{G} intensity ratio is a frequently used indicator of defects on carbon materials including CNTs as higher I_{D}/I_{G} ratio indicates more defects in the sample. FIG. 4 compares the Raman spectra of raw CNTs and air-annealed CNTs. Analysis of Raman spectra given in FIG. 4 revealed that the I_{D}/I_{G} ratios in samples A4 and B1 are very similar to that of the untreated raw CNTs. In fact, the I_{D}/I_{G} ratio for sample B1 is slightly lower than that of the raw CNTs (0.91 versus 0.94), which is probably due to selective removal of amorphous carbon impurities in the CNTs during annealing at 500° C. On the other hand, the I_{D}/I_{G} ratios of a sample treated at 650° C. and the acid treated CNTs are significantly higher at 1.15 and 1.12, respectively, which mean that there are more severe structural damages in both samples. In fact, the Raman spectrum of the acid treated CNTs show apparent band shift which is likely due to the formation of the amorphous layer on the CNTs surfaces during acid treatment. This again shows the advantage that functionalization of CNTs via air annealing under controlled conditions is much less invasive in causing structural damages.

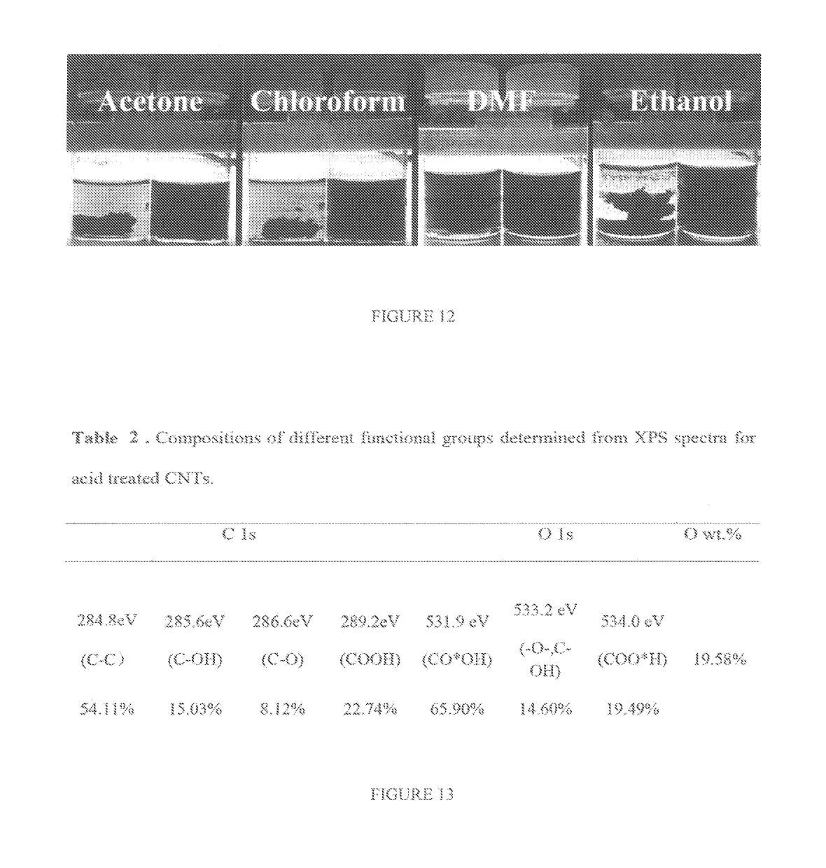

Unlike acid treated CNTs which disperse well mostly in aqueous medium and certain high polar solvents, air annealed samples A4 and B1 can be dispersed in several polar organic solvents. Besides in ethanol, the annealed samples show excellent dispersion behavior in common organic solvents including acetone, chloroform and DMF (see FIG. 12). It should be pointed out that such excellent dispersion of treated CNTs (with little or no structural damage) in organic solvents is a highly desirable characteristic in order to maintain the intrinsic properties and structural integrity of CNTs. This is particularly important for the applications of CNTs, e.g., as conductive coatings or electrodes.

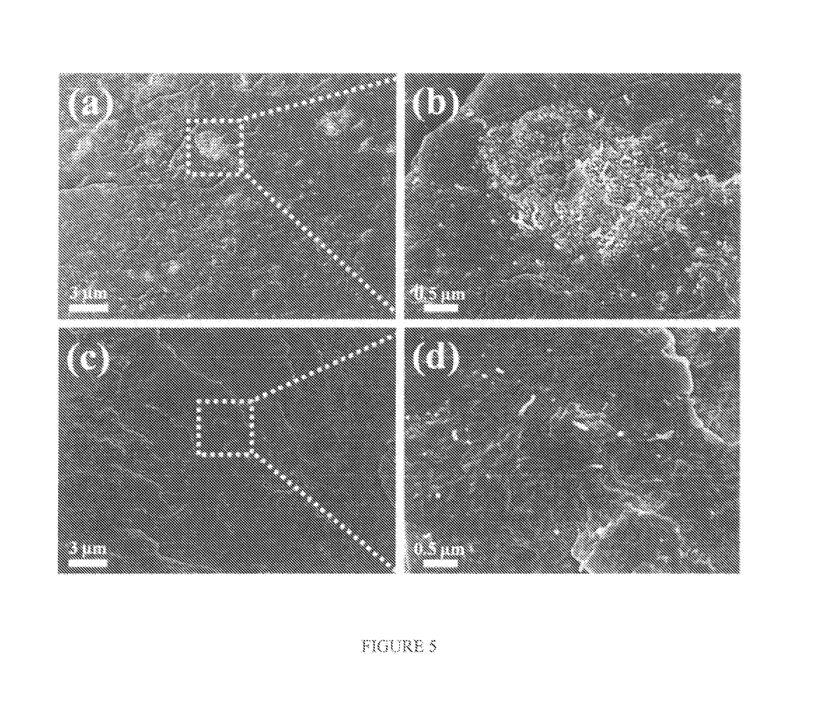

Furthermore, excellent dispersion in organic solvents is an indication that the CNTs treated by the facile air-annealing may be easily dispersed into polymer matrices. To illustrate such a potential in CNT/polymer composites, dispersion of air-annealed CNTs is compared with the raw CNTs in a PVDF matrix. FIG. 5 compares the FE-SEM images of an air-annealed CNT sample (sample A4) and raw CNTs, both 0.2 wt %, in PVDF prepared using the same mixing method. It can be seen that raw CNTs form distinct and large aggregations in the polymer matrix (see (a) and (b) of FIG. 5), while the nanotubes of sample A4 are individually dispersed and uniformly distributed throughout the polymer matrix (see (c) and (d) of FIG. 5). Achieving such a remarkable dispersion of CNTs in a polymer matrix is difficult so far without lengthy and laborious treatment procedures, which are difficult and costly to implement in large scale. Therefore, it is believed that this facile method of functionalization via air annealing should be highly significant and useful for various applications of CNTs.

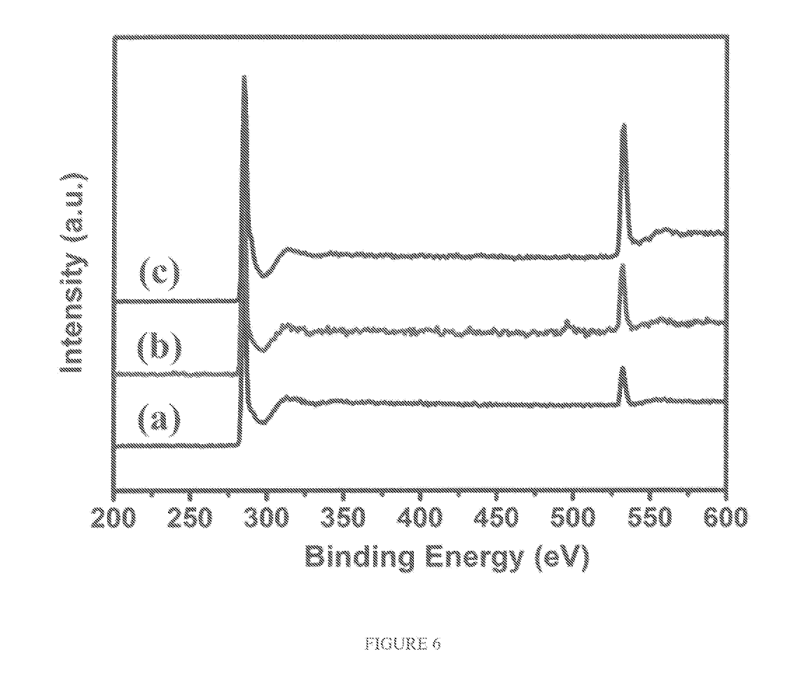

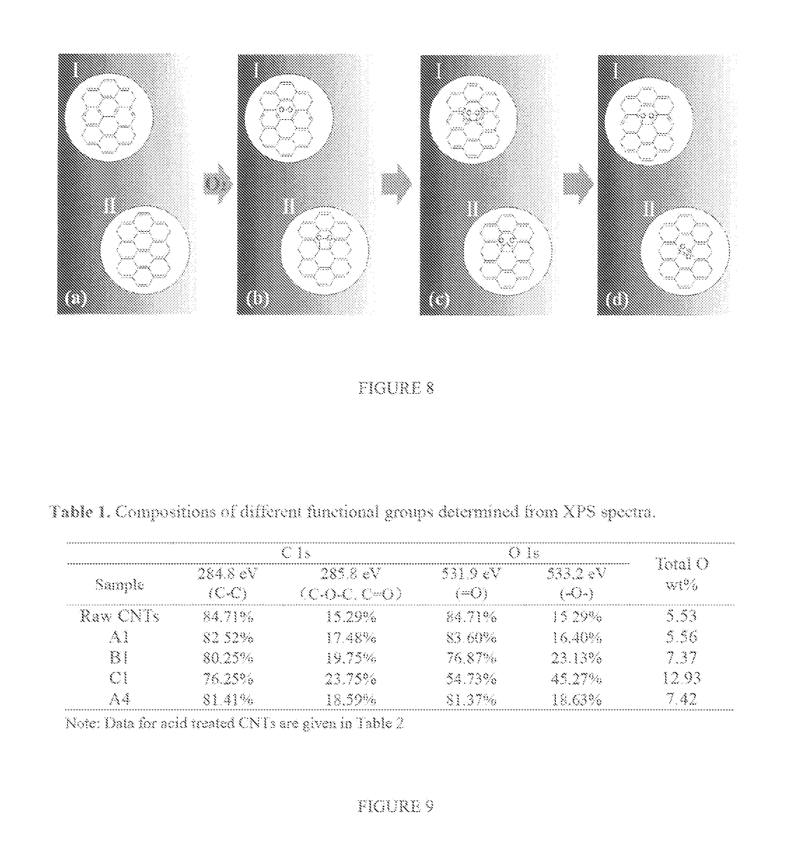

XPS is a useful tool to study the elemental compositions and functional groups on CNTs. In order to understand the detailed mechanisms of the surface functionalization, both qualitative and quantitative analyses of the air-annealed CNTs are carried out using XPS. FIG. 6 compares C 1s and O 1s XPS spectra of raw CNTs, air-annealed CNTs and acid treated CNTs. The oxygen content found in raw CNTs is due to impurities or catalyst residues. The oxygen content clearly increases in sample (C1) which was rather severely annealed at 550° C. for 30 min. However, the oxygen content is still lower than that in the acid treated CNTs. XPS observation is in agreement with TEM and Raman analysis discussed earlier. This again suggests that air-annealing can be a controllable and less invasive surface functionalization of CNTs. It is important to note that appreciable increase in the oxygen content compared with raw CNTs is only observed in samples treated at 450° C. and above. The total oxygen contents of a series of selected samples are summarized in the last column in Table 1, FIG. 9. The oxygen contents are 5.56, 7.37, 7.42, and 12.93% (C1) for samples A1, B1, A4 and C1, respectively, showing a gradual increasing trend at higher temperature/longer duration as expected.

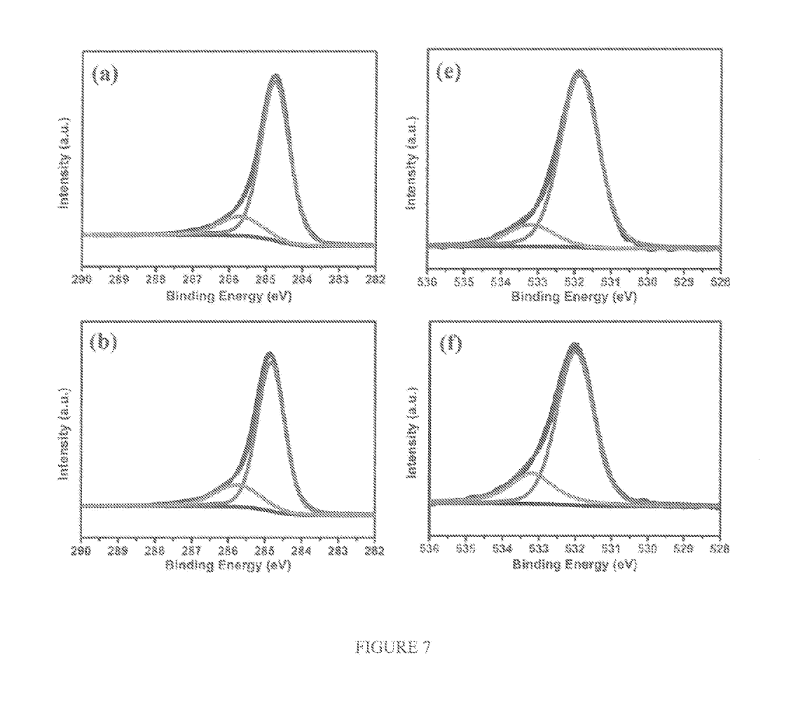

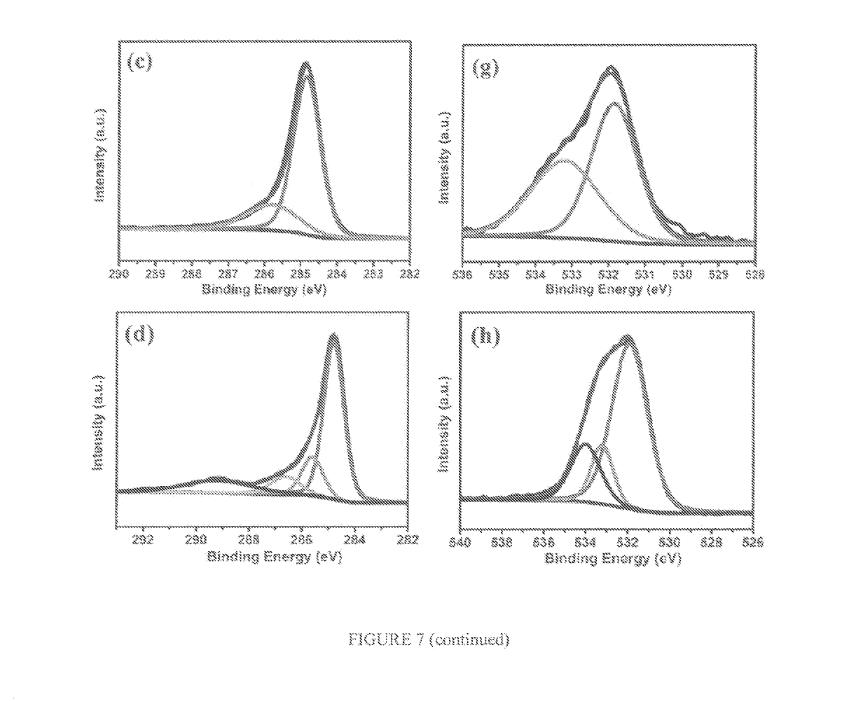

More detailed information on the functional groups is obtained by further quantitative analysis of the XPS spectra. The deconvoluted C 1s and O 1s spectra are given in FIG. 7. The C 1s peak for raw CNTs and air-annealed CNTs can be fitted into two sub-peaks. The major peak with a binding energy at 284.8 eV corresponds to sp² hybridized carbon atoms of the graphitic structure in the CNTs while the minor peak at 285.8 eV is assigned to sp³ atoms bonded to oxygen. The sp2 hybridized carbon contents are calculated to be 84.71 82.52, 81.41, 80.25, and 76.25% for raw CNTs and air annealed samples A1, A4, B1 and C1, respectively (FIG. 9, Table 1, first column). There is only a small reduction of sp² carbon content in the annealed samples. However, in comparison, the corresponding graphitic sp² hybridized carbon content in acid treated CNTs is measured to be only 54.11% (FIG. 14, Table 2), which is substantially lower than any one of the air-annealed CNTs. This quantifies the extent of damage of the graphitic structure during acid treatment is far greater than air-annealing. Correspondingly, the O 1s spectra can also be fitted into two peaks. The lower binding energy peak at 531.9 eV is assigned to be quinone groups (C═O) and the other peak at 533.2 eV belongs to ether groups (C—O—C). Closer examination of the functional group contents summarized in Table 1, FIG. 9 further reveals that increasing annealing temperature seems to have more significant effect on contents of C—O—C and C═O functional groups than increasing annealing time (C 1s Table 1, FIG. 9). Data derived from O is spectra in Table 1, FIG. 9 show that the relative contents of —O— (related to C—O—C) and ═O (related to C═O) are very different when annealed at 450, 500, and 550° C. It is important to note that higher annealing temperatures have clearly favored the formation of ether groups (C—O—C) at the expense of quinone groups (C═O). For example, the C—O—C group content out of the total amount of functional groups in sample A1 treated at 450° C. is 16.40%. It increased to 45.25% in sample C1 treated at 550° C. It is also noted that samples B1 (30 min@500° C.) and A1 (120 min@450° C.) have almost the same total oxygen content, i.e., 7.37 and 7.42%. However, the C—O—C to C═O ratio in sample B1 is 0.30 while that in A1 is 0.23. These observations indicate that shorter duration/higher temperature annealing leads to more C—O—C groups than longer duration/lower temperature annealing, while the latter (i.e. longer duration/lower temperature annealing) yields more C═O groups.

For comparison, (d) and (h) of FIG. 7 illustrate the deconvolution of C 1s and O 1s spectra of acid treated CNTs into four different carbon states and three oxygen states, respectively. This shows that acid oxidation leads to very different types of functional groups compared with air annealing. Besides the main peak of graphitic sp² at 284.8 eV, peaks at 285.6, 286.6, and 289.2 eV indicate presence of C—OH, C—O—C and COOH, two of which are absent in air annealed samples. The major oxygen peak at 531.9 eV is from COOH, while the peak at 533.2 eV is from ether and hydroxyl groups. However, it is worth highlighting that no hydroxyl or carboxylic groups are found in any one of the air annealed CNTs. It is believed that the absence of these two groups is an important reason to explain why the air annealed CNTs can be dispersed in organic solvents rather than aqueous solutions.

Based on XPS analysis, it is herein proposed the possible reactions mechanism for the formation of surface ether and quinone groups on CNTs during air annealing. The proposed mechanism is illustrated in FIG. 8. To form C—O—C group, the first and also the rate determining step is the 1,4 peroxidation. Then the π-electrons in the two adjacent C═C bonds rearrange and simultaneously form single bonds to the two oxygen atoms, while the —O—O— bond breaks homolytically as depicted in route I in FIG. 8.

On the other hand, the formation of C═O groups is likely to begin with a 1,2 peroxidation on the graphitic ring, and this is followed by simultaneous hemolytic breaking of C—C and O—O bond, leading to the formation of two quinone groups (route II in FIG. 8). It is seen in XPS analysis that lower temperature is less favorable in generating C—O—C groups, meaning that a low temperature is less favorable to 1,4 peroxidation. This can be reasonably expected that the activation energy for 1,4 peroxidation in the planar graphitic ring is higher than that for 1,2 peroxidation.

### CONCLUSIONS

Air-annealing was found to be an effective route for surface functionalization of CNTs. This is a facile method which leads to high yield of treated CNTs up to 90%. The surface functionalization of both ether C—O—C and quinone C═O groups is uniform, enabling the excellent dispersion of the treated CNTs in organic solvents including ethanol, acetone, chloroform, and DMF. A plausible reaction mechanism was proposed based on detailed XPS spectroscopic analysis. It was found that the air annealing treatment caused minimal damage to the CNTs as can be seen from both Raman and TEM analyses. In fact, XPS data also confirmed quantitatively that the air annealed CNTs have very little reduction in sp² graphitic carbon structure and yet can be uniformly dispersed in different organic solvents. Quantitative results show that there is a clear advantage of low structural damage during air-annealing in comparison to acid treatment. It is thus strongly believed that this facile and eco-friendly functionalization method is potentially scalable and is useful in many different applications involving CNTs.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### REFERENCES

1. Baughman, R. H.; Zakhidov, A. A.; de Heer, W. A., Carbon nanotubes—the route toward applications. Science 2002, 297 (5582), 787-792.
2. Bachtold, A.; Hadley, P.; Nakanishi, T.; Dekker, C., Logic circuits with carbon nanotube transistors. Science 2001, 294 (5545), 1317-1320.
3. Ren, S.; Bernardi, M.; Lunt, R. R.; Bulovic, V.; Grossman, J. C.; Gradecak, S., Toward efficient carbon nanotube/p3ht solar cells: active layer morphology, electrical, and optical properties. Nano letters 2011, 11 (12), 5316-5321.
4. Qin, S.; Qin, D.; Ford, W. T.; Herrera, J. E.; Resasco, D. E.; Bachilo, S. M.; Weisman, R. B., Solubilization and purification of single-wall carbon nanotubes in water by in situ radical polymerization of sodium 4-styrenesulfonate. Macromolecules 2004, 37 (11), 3965-3967.
5. Spitalsky, Z.; Tasis, D.; Papagelis, K.; Galiotis, C., Carbon nanotube-polymer composites: chemistry, processing, mechanical and electrical properties. Progress in Polymer Science 2010, 35 (3), 357-401.
6. Mazov, I.; Kuznetsov, V. L.; Simonova, I. A.; Stadnichenko, A. I.; Ishchenko, A. V.; Romanenko, A. I.; Tkachev, E. N.; Anikeeva, O. B., Oxidation behavior of multiwall carbon nanotubes with different diameters and morphology. Applied Surface Science 2012, 258 (17), 6272-6280.
7. Chen, J.; Liu, H.; Weimer, W. A.; Halls, M. D.; Waldeck, D. H.; Walker, G. C., Noncovalent engineering of carbon nanotube surfaces by rigid, functional conjugated polymers. Journal of the American Chemical Society 2002, 124 (31), 9034-9035.
8. Star, A.; Stoddart, J. F.; Steuerman, D.; Diehl, M.; Boukai, A.; Wong, E. W.; Yang, X.; Chung, S. W.; Choi, H.; Heath, J. R., Preparation and properties of polymer-wrapped single-walled carbon nanotubes. Angewandte Chemie International Edition 2001, 40 (9), 1721-1725.
9. Shin, Y.-R.; Jeon, I.-Y.; Baek, J.-B., Stability of multi-walled carbon nanotubes in commonly used acidic media. Carbon 2012, 50 (4), 1465-1476.
10. Pimenta, M.; Dresselhaus, G.; Dresselhaus, M. S.; Cancado, L.; Jorio, A.; Saito, R., Studying disorder in graphite-based systems by Raman spectroscopy. Physical Chemistry Chemical Physics 2007, 9 (11), 1276-1290.
11. Li, C.; Wang, D.; Liang, T.; Wang, X.; Wu, J.; Hu, X.; Liang, J., Oxidation of multiwalled carbon nanotubes by air: benefits for electric double layer capacitors. Powder technology 2004, 142 (2), 175-179.
12. Moonoosawmy, K. R.; Kruse, P., Ambiguity in the Characterization of Chemically Modified Single-Walled Carbon Nanotubes: A Raman and Ultraviolet-Visible-Near-Infrared Study. The Journal of Physical Chemistry C 2009, 113 (13), 5133-5140.
13. Osswald, S.; Flahaut, E.; Ye, H.; Gogotsi, Y., Elimination of D-band in Raman spectra of double-wall carbon nanotubes by oxidation. Chemical Physics Letters 2005, 402 (4), 422-427.
14. Roy, S.; Das, T.; Ming, Y.; Chen, X.; Yue, C. Y.; Hu, X., Specific functionalization and polymer grafting on multiwalled carbon nanotubes to fabricate advanced nylon 12 composites. Journal of Materials Chemistry A 2014, 2 (11), 3961-3970.
15. Lee, H.-J.; Oh, S.-J.; Choi, J.-Y.; Kim, J. W.; Han, J.; Tan, L.-S.; Baek, J.-B., In situ synthesis of poly (ethylene terephthalate)(PET) in ethylene glycol containing terephthalic acid and functionalized multiwalled carbon nanotubes (MWNTs) as an approach to MWNT/PET nanocomposites. Chemistry of materials 2005, 17 (20), 5057-5064.
16. Roy, S.; Das, T.; Yue, C. Y.; Hu, X., Improved Polymer Encapsulation on Multiwalled Carbon Nanotubes by Selective Plasma Induced Controlled Polymer Grafting. ACS applied materials & interfaces 2013, 6 (1), 664-670.
17. Tang, X.-Z.; Cao, Z.; Zhang, H.-B.; Liu, J.; Yu, Z.-Z., Growth of silver nanocrystals on graphene by simultaneous reduction of graphene oxide and silver ions with a rapid and efficient one-step approach. Chem. Commun. 2011, 47 (11), 3084-3086.
18. Tang, X.-Z.; Li, X.; Cao, Z.; Yang, J.; Wang, H.; Pu, X.; Yu, Z.-Z., Synthesis of graphene decorated with silver nanoparticles by simultaneous reduction of graphene oxide and silver ions with glucose. Carbon 2013, 59, 93-99.
19. Compton, O. C.; Dikin, D. A.; Putz, K. W.; Brinson, L. C.; Nguyen, S. T., Electrically conductive “alkylated” graphene paper via chemical reduction of amine-functionalized graphene oxide paper. Advanced Materials 2010, 22 (8), 892-896.
20. Luo, Z.; Lim, S.; Tian, Z.; Shang, J.; Lai, L.; MacDonald, B.; Fu, C.; Shen, Z.; Yu, T.; Lin, J., Pyridinic N doped graphene: synthesis, electronic structure, and electrocatalytic property. Journal of Materials Chemistry 2011, 21 (22), 8038-8044.
21. Zhang, L.; Ji, L.; Glans, P.-A.; Zhang, Y.; Zhu, J.; Guo, J., Electronic structure and chemical bonding of a graphene oxide-sulfur nanocomposite for use in superior performance lithium-sulfur cells. Physical Chemistry Chemical Physics 2012, 14 (39), 13670-13675.
22. Biniak, S.; Szymański, G.; Siedlewski, J.; Światkowski, A., The characterization of activated carbons with oxygen and nitrogen surface groups. Carbon 1997, 35 (12), 1799-1810.
23. Haubner, K.; Murawski, J.; Olk, P.; Eng, L. M.; Ziegler, C.; Adolphi, B.; Jaehne, E., The route to functional graphene oxide. ChemPhysChem 2010, 11 (10), 2131-2139.
24. Soo-Jin Park; Ki-Seok Kim, Surface characterization of carbon materials by X-ray photoelectron spectroscopy. Microscopy: Science, Technology, Application and Education 2010, 1905-1916.
25. Nikolay Dementev; Sebastian Osswald; Yury Gogotsi; Eric Borguet, Purification of carbon nanotubes by dynamic oxidation in air. Journal of Materials Chemistry 2009, 19, 7904-7908.
26. K. Behler; S. Osswald; H. Ye; S. Dimovski; Y. Gogosti, Effect of thermal treatment on the structure of multi-walled carbon nanotubes. Journal of Nanoparticle Research 2006, 8, 615-625.

1. A method of functionalizing surfaces of carbon nanomaterials using oxygen in the air, the method comprising:
annealing the carbon nanomaterials with air; and
supplying one or more diluent gases to the carbon nanomaterials during the annealing, wherein the one or more diluent gases are inert to the functionalization of the carbon nanomaterials surfaces.

2. The method of claim 1, wherein the one or more diluent gases comprise nitrogen, helium, argon, krypton, xenon, carbon dioxide or radon.

3. The method of claim 2, wherein the one or more diluent gases comprise nitrogen.

4. The method of claim 3, wherein the diluent gas consists of nitrogen.

5. The method of claim 1, wherein the volume ratio of air to the one or more diluent gases is between 1:2 and 1:20.

6. The method of claim 5, wherein the volume ratio of air to the one or more diluent gases is between 1:5 and 1:15.

7. The method of claim 6, wherein the volume ratio of air to the one or more diluent gases is 1:10.

8. The method of claim 1, wherein annealing comprises annealing at a temperature between 450 and 550° C.

9. The method of claim 1, wherein annealing further comprises annealing at a heating rate of 5° C./min.

10. The method of claim 1, wherein annealing comprises annealing for 150 min or less.

11. The method of claim 10, wherein annealing comprises annealing for 30 to 120 min.

12. The method of claim 1, wherein the carbon nanomaterials comprise single-walled, double-walled, or multi-walled carbon nanotubes, carbon nanofibers, graphene, activated carbons, carbon blacks, carbon onions, or nanoscale diamond and diamondoids.
